(19) United States
(12) Patent Application Publication
(10) Pub. No.: US 2025/0201477 A1
(43) Pub. Date: Jun. 19, 2025

(54) MULTILAYER CERAMIC ELECTRONIC DEVICE AND MANUFACTURING METHOD OF THE SAME

(71) Applicant: TAIYO YUDEN CO., LTD., Tokyo (JP)

(72) Inventors: Kyousuke SHIMAZAKI, Tokyo (JP); Jun NISHIKAWA, Tokyo (JP); Masaki SAITOU, Tokyo (JP)

(73) Assignee: TAIYO YUDEN CO., LTD., Tokyo (JP)

(21) Appl. No.: 19/072,380

(22) Filed: Mar. 6, 2025

Related U.S. Application Data
(63) Continuation of application No. PCT/JP2023/033293, filed on Sep. 13, 2023.

(30) Foreign Application Priority Data
Sep. 20, 2022 (JP) 2022-149439

(51) Int. Cl. H01G 4/224; H01G 4/30

(52) U.S. Cl. CPC H01G 4/224; H01G 4/30

(57) ABSTRACT

A multilayer ceramic electronic device includes a multilayer section, a side margin section that is provided on a side surface facing in a first direction, and an external electrode that is provided on an end surface facing in a second direction and is connected to at least one of the plurality of internal electrode layers. When viewing a cross section of the multilayer section along a stacking direction and the first direction, at least at one corner of the multilayer section, a first end of the side margin section in the stacking direction contacts a second end of the cover layer in the first direction from the stacking direction. A ratio of a distance in the first direction between a tip of the first end of the side margin section and the side surface to a thickness of the cover layer in the stacking direction is 2.8 or less.

### CROSS-REFERENCE TO RELATED APPLICATION

This application is a continuation application of PCT/JP2023/033293 filed on Sep. 13, 2023, which claims priority to Japanese Patent Application No. 2022-149439 filed on Sep. 20, 2022, the contents of which are herein wholly incorporated by reference.

### FIELD

A certain aspect of the present invention relates to a multilayer ceramic electronic device and a manufacturing method of the multilayer ceramic electronic device.

### BACKGROUND

Multilayer ceramic capacitors include a multilayer section in which internal electrodes and dielectric layers are alternately stacked, and side margin sections that cover both side surfaces of the multilayer section (see, for example, Japanese Patent Application Publication No. 2020-113575, Japanese Patent Application Publication No. 2021-108398, and Japanese Patent Application Publication No. 2022-27939). The side margin sections may be formed after the formation of the multilayer section in order to improve electrostatic capacity by eliminating the need for design margins that take into account the printing accuracy of the internal electrodes and the accuracy of the stacking. One method for forming the side margin sections is, for example, to press the side surface of the multilayer section against a green sheet, and then to separate a portion of the green sheet attached to the side surface from the rest of the sheet to form the side margin section.

### SUMMARY OF THE INVENTION

According to an aspect of the present invention, there is provided a multilayer ceramic electronic device including: a multilayer section that has a substantially rectangular parallelepiped shape and includes each of a plurality of internal electrode layers and each of a plurality of dielectric layers which are alternately stacked, and a cover layer provided outside in a stacking direction of the plurality of internal electrode layers and the plurality of dielectric layers; a side margin section that is provided on a side surface facing in a first direction orthogonal to the stacking direction among six surfaces of the multilayer section; and an external electrode that is provided on an end surface facing in a second direction orthogonal to the first direction and the stacking direction among the six surfaces of the multilayer section and is connected to at least one of the plurality of internal electrode layers, wherein, when viewing a cross section of the multilayer section along the stacking direction and the first direction, at least at one corner of the multilayer section, a first end of the side margin section in the stacking direction contacts a second end of the cover layer in the first direction from the stacking direction, and wherein a ratio of a distance in the first direction between a tip of the first end of the side margin section and the side surface to a thickness of the cover layer in the stacking direction is 2.8 or less.

According to another aspect of the present invention, there is provided a manufacturing method of a multilayer ceramic electronic device including: polishing a multilayer section that has a substantially rectangular parallelepiped shape and includes each of a plurality of internal electrode layers and each of a plurality of dielectric layers which are alternately stacked, and a cover layer provided outside in a stacking direction of the plurality of internal electrode layers and the plurality of dielectric layers; forming a side margin section that is provided on a side surface facing in a first direction orthogonal to the stacking direction among six surfaces of the multilayer section; and forming an external electrode that is provided on an end surface facing in a second direction orthogonal to the first direction and the stacking direction among the six surfaces of the multilayer section and is connected to at least one of the plurality of internal electrode layers, wherein, in the forming of the side margin section, the side margin section is formed so that, when viewing a cross section of the multilayer section along the stacking direction and the first direction, at least at one corner of the multilayer section, a first end of the side margin section in the stacking direction contacts a second end of the cover layer in the first direction from the stacking direction, and a ratio of a distance in the first direction between a tip of the first end of the side margin section and the side surface to a thickness of the cover layer in the stacking direction is 2.8 or less.

### BRIEF DESCRIPTION OF THE DRAWINGS

FIG. 1 illustrates a perspective view of a multilayer ceramic capacitor in which a cross section of a part of the multilayer ceramic capacitor is illustrated;

FIG. 2 illustrates a cross sectional view of a multilayer ceramic capacitor taken along a line A-A of FIG. 1;

FIG. 3A illustrates a cross sectional view of a multilayer ceramic capacitor taken along a line B-B of FIG. 1;

FIG. 3B illustrates a cross sectional view of a comparative multilayer ceramic capacitor taken along a line B-B of FIG. 1;

FIG. 4 illustrates a manufacturing method of a multilayer ceramic capacitor;

FIG. 5 illustrates a cross sectional view of an example of a stacking process;

FIG. 6 illustrates a side view of a multilayer section 2s of an example of a polishing process;

FIG. 7 illustrates a side view (part 1) of an example of a side margin forming process when an end surface of a multilayer section is viewed from a front;

FIG. 8 illustrates a side view (part 2) of an example of a side margin forming process when an end surface of a multilayer section is viewed from a front; and

FIG. 9 illustrates a side view (part 3) of an example of a side margin forming process when an end surface of a multilayer section is viewed from a front.

### DETAILED DESCRIPTION

However, when the side margin section is formed as described above, the side margin section may peel off from the multilayer portion due to stress caused by the difference in thermal shrinkage rate between the side margin section and the multilayer portion during the firing process of the multilayer ceramic capacitor. If the side margin section peels off, moisture may enter through the gap caused by the peeling, degrading the characteristics of the multilayer ceramic capacitor.

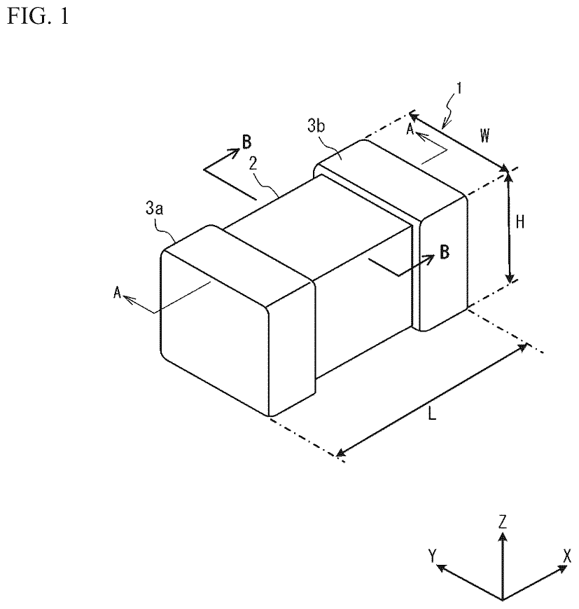

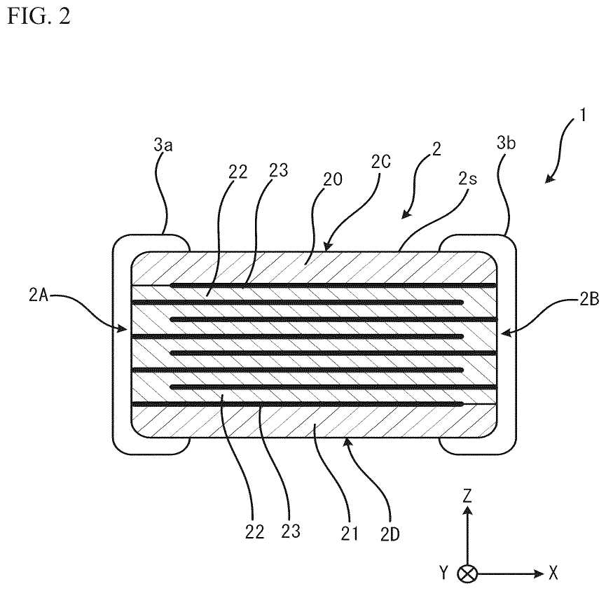

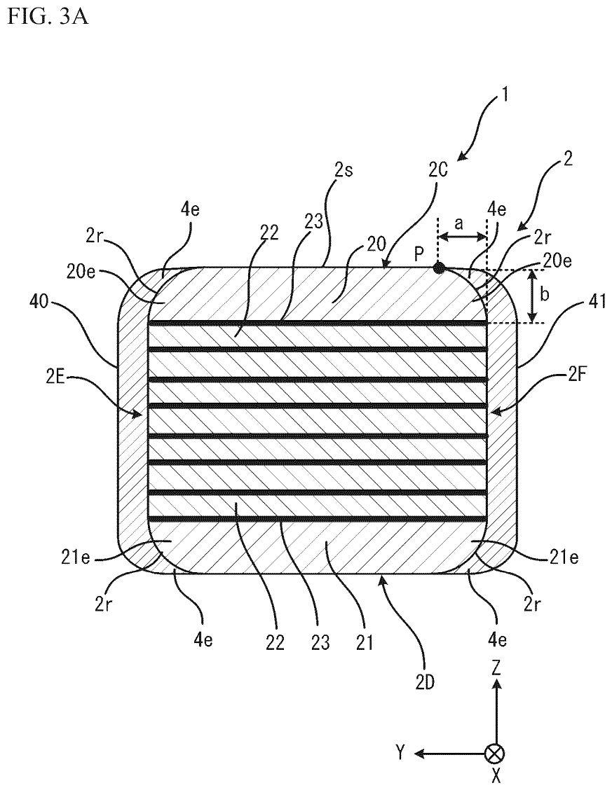

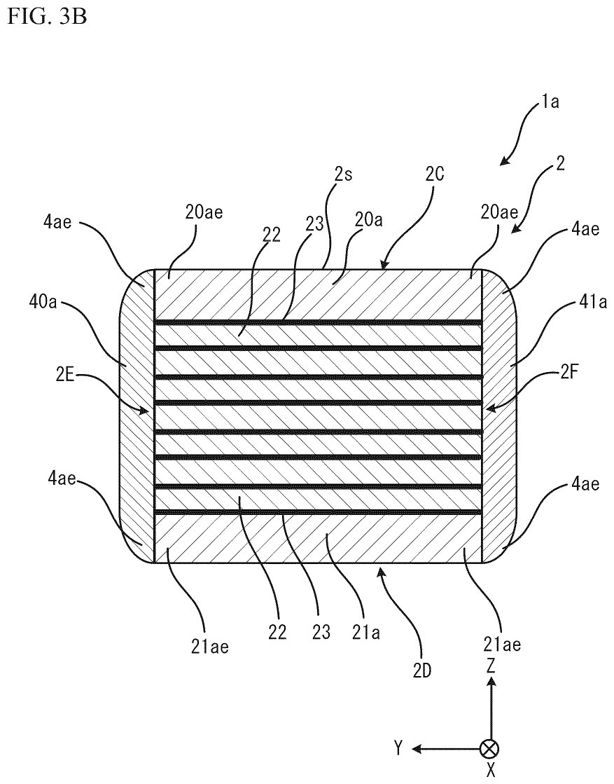

FIG. 1 is a perspective view of an example of a multilayer ceramic capacitor 1 according to an embodiment. FIG. 2 is a cross-sectional view of the multilayer ceramic capacitor 1 taken along a line A-A in FIG. 1. FIG. 3A is a cross-sectional view of the multilayer ceramic capacitor 1 taken along a line B-B in FIG. 1.

The multilayer ceramic capacitor 1 is an example of a multilayer ceramic electronic device. The multilayer ceramic capacitor 1 has a multilayer chip 2 having a substantially rectangular parallelepiped shape, and external electrodes 3a and 3b provided on a pair of end surfaces 2A and 2B that face each other in the length direction of the multilayer chip 2.

FIG. 1 to FIG. 3A illustrate the X, Y, and Z directions that are mutually orthogonal. The X direction is the length (L) direction of the multilayer ceramic capacitor 1, and corresponds to the direction in which the pair of end surfaces of the multilayer chip 2 face each other. The Y direction is the width (W) direction of the multilayer ceramic capacitor 1, and corresponds to the direction in which the pair of side surfaces of the multilayer chip 2 face each other. The Z direction is the height (H) direction of the multilayer ceramic capacitor 1, and corresponds to the stacking direction of the multilayer ceramic capacitor 1. The width direction is an example of the first direction, and the length direction is an example of the second direction.

As illustrated in FIG. 3A, the multilayer chip 2 has a multilayer section 2s having a multilayer structure and a substantially rectangular parallelepiped shape, and a pair of side margin sections 40 and 41 covering a pair of side surfaces 2E and 2F of the multilayer section 2s that face each other in the width direction of the multilayer ceramic capacitor 1. The multilayer section 2s includes dielectric layers 22 containing a ceramic material that functions as a dielectric and internal electrode layers 23 that are alternately stacked, and further includes a pair of cover layers 20 and 21 that are stacked so as to sandwich the dielectric layers 22 and the internal electrode layers 23 from both sides in the stacking direction. The side margin sections 40 and 41 are arranged adjacent to both ends of each internal electrode layer 23 that is drawn out and exposed on the pair of side surfaces 2E and 2F of the multilayer section 2s. As a result, the cover layers 20 and 21 and the side margin sections 40 and 41 protect the internal electrode layers 23.

The internal electrode layer 23 is mainly composed of a base metal such as Ni (nickel), Cu (copper), or Sn (tin). The internal electrode layer 23 may contain Sn or a noble metal such as Pt (platinum), Pd (palladium), Ag (silver), or Au (gold), and an alloy containing these metals may be used as the main component of the internal electrode layer 23.

A main component of the dielectric layer 22 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr₂O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like.

Furthermore, the cover layers 20 and 21 are mainly composed of a ceramic material. For example, the material of the cover layers 20 and 21 has the same main component as the ceramic material of the dielectric layer 22. The cover layers 20 and 21 are provided on the outer sides of each dielectric layer 22 in the stacking direction, and constitute the upper surface 2C and the lower surface 2D of the multilayer section 2s in the stacking direction.

The side margin sections 40 and 41 are mainly made of ceramic material. For example, the material of the side margin sections 40 and 41 is mainly made of the same ceramic material as the dielectric layer 22. The side margin sections 40 and 41 are formed on the side surfaces 2E and 2F of the multilayer section 2s after the multilayer section is formed.

The external electrodes 3a and 3b cover the end surfaces 2A and 2B of the multilayer section 2s that face each other in the length direction. Here, the length direction is an example of the second direction that is approximately perpendicular to the stacking direction and the width direction, and is the direction in which the internal electrode layer 23 is drawn out. The external electrodes 3a and 3b extend to the upper surface 2C, the lower surface 2D, and the two side surfaces 2E and 2F. However, the external electrodes 3a and 3b are spaced apart from each other on the upper surface 2C, the lower surface 2D, and the two side surfaces 2E and 2F.

The external electrodes 3a and 3b contain, as their base metal film, a metal such as Cu, Ni, Al (aluminum), or Zn (zinc), or an alloy of two or more of these metals (for example, an alloy of Cu and Ni), and contain ceramics such as a glass component for densifying the external electrodes 3a and 3b, and a co-material for controlling the sintering property of the external electrodes 3a and 3b. The glass component is an oxide of Ba (barium), Sr (strontium), Ca (calcium), Zn (zinc), Al, Si (silicon), B (boron), or the like. The co-material is, for example, a ceramic component whose main component is the same material as the main component of the dielectric layer 22.

The external electrodes 3a and 3b may also include a plated layer covering the base metal film. The plated layer may be mainly composed of a base metal such as Ni, Cu, or Sn. Furthermore, a layer of conductive resin such as epoxy resin or urethane resin may be formed between the base metal film and the plated layer.

As can be seen from FIG. 2, the edges of each internal electrode layer 23 in the length direction are alternately drawn out and exposed to the end surface 2A of the multilayer chip 2 on which the external electrode 3a is provided and the end surface 2B of the multilayer chip 2 on which the external electrode 3b is provided. As a result, each internal electrode layer 23 is alternately conductive to the external electrode 3a and the external electrode 3b in the stacking direction. In other words, each of the external electrodes 3a and 3b on each of the end surfaces 2A and 2B is alternately connected to each internal electrode layer 23 along the stacking direction.

As can be seen from FIG. 3A, in the cross section of the multilayer chip 2 along the stacking direction and the width direction, at the four corners 2r of the multilayer section 2s, the ends 4e of the side margin sections 40 and 41 in the stacking direction are in contact with the ends 20e and 21e of the cover layers 20 and 21 in the width direction from the stacking direction. As a result, the ends 20e and 21e of the cover layers 20 and 21 are covered by the ends 4e of the side margin sections 40 and 41.

Each of the ends 20e and 21e of the cover layers 20 and 21 has a curved shape with rounded corners by polishing. The ends 4e of the side margin sections 40 and 41 in the stacking direction are extended so as to overlap the area of this curved shape and cover the area on the center side in the width direction.

FIG. 3B is a cross section of a comparative multilayer ceramic capacitor 1a along a line B-B in FIG. 1. In FIG. 3B, the same components as in FIG. 3A are given the same reference numerals, and their description will be omitted. The comparative multilayer ceramic capacitor 1a has side margin sections 40a and 41a instead of the side margin sections 40 and 41, and the cover layers 20a and 21a instead of the cover layers 20 and 21.

Unlike the multilayer ceramic capacitor 1 of the embodiment, the ends 20ae and 21ae of the cover layers 20a and 21a in the width direction of the multilayer chip 2 are not curved, but have approximately right-angled corners. Therefore, the boundary between the end 4ae in the stacking direction of the side margin sections 40a and 41a and the ends 20ae and 21ae in the width direction of the cover layers 20a and 21a is not curved, but is approximately linear along the stacking direction. Therefore, the ends 4ae of the side margin sections 40a and 41a contact the ends 20ae and 21ae of the cover layers 20a and 21a in the width direction, not in the stacking direction of the multilayer chip 2.

On the other hand, as can be seen from FIG. 3A, in the multilayer ceramic capacitor 1, each of the ends 4e in the stacking direction of the side margin sections 40 and 41 contacts each of the ends 20e and 21e in the width direction of the cover layers 20 and 21 in the stacking direction, increasing the contact area between the side margin sections 40 and 41 and the multilayer section 2s, and therefore increasing the adhesion of the side margin sections 40 and 41 to the multilayer section 2s. Therefore, peeling of the side margin sections 40 and 41 from the multilayer section 2s is suppressed.

Since peeling of the side margin sections 40 and 41 often starts from the end 4e, increasing the adhesion of the end 4e of the side margin sections 40 and 41 using the above structure is an effective measure against peeling. It is preferable that the tip P of the end 4e of the side margin section 41 is connected to the surface of the cover layer 20 without forming a step, but even if there is a step of, for example, 10 (μm) or less, there is no problem in suppressing peeling. Note that each of the ends 4e of the side margin sections 40 and 41 in the stacking direction of the multilayer chip 2 is an example of a first end, and each of the ends 20e and 21e of the cover layers 20 and 21 in the width direction of the multilayer section 2s is an example of a second end.

At each of the corners 2r of the multilayer section 2s, a curved surface that is convex outward is formed by, for example, barrel polishing. The end 4e of the side margin section 41 contacts the curved surface of the corner 2r provided at each of the ends 20e and 21e of the cover layers 20 and 21 in the stacking direction. For this reason, the ends 4e of the side margin sections 40 and 41 are formed to extend toward the center in the width direction along the curved surface of the corners 2r. Therefore, the contact area between the side margin sections 40 and 41 and the multilayer section 2s is larger than when the corners 2r are formed as flat surfaces rather than curved surfaces, making it possible to increase the adhesion.

The greater the degree of curving of the curved surface of the corner 2r is, the greater the contact area between the side margin sections 40 and 41 and the multilayer section 2s is. Here, as illustrated in FIG. 3A, the thickness of the cover layer 20 in the stacking direction is b (μm), the distance in the width direction between the tip P of the end 4e of the side margin section 41 and the side surfaces 2E and 2F of the multilayer section 2s is a (μm), and the ratio of the distance “a” to the thickness “b” (a/b) is defined as the parameter “R” indicating the degree of curving. The parameter “R” can be adjusted by the conditions for barrel polishing the multilayer section 2s (for example, time or the like) and the density of the green sheets of the material of the cover layers 20 and 21.

The parameter “R” of the multilayer ceramic capacitor 1 of the embodiment is greater than 0. The larger the parameter “R” is, the greater the adhesion between the side margin sections 40, 41 and the multilayer section 2s is, making it more difficult for them to peel off. Also, the larger the parameter “R” is, the longer the distance from the outside to the internal electrode layer 23 is along the boundary between the side margin sections 40, 41 and the multilayer section 2s. Moisture easily penetrates into the interior along the boundaries between the side margin sections 40, 41 and the multilayer section 2s. The larger the parameter “R” is, the longer the penetration path is, improving the moisture resistance of the multilayer ceramic capacitor 1.

When the parameter “R” is 0.2 or more, a sufficiently large adhesion is obtained between the multilayer section 2s and the side margin sections 40, 41, so peeling of the side margin sections 40, 41 can be more effectively suppressed. Furthermore, when the parameter “R” is 0.5 or more, the penetration path of moisture becomes sufficiently long, which is more preferable. Furthermore, when the parameter “R” is 2.8 or less, the formation of the side margin sections 40 and 41 becomes easier, which is preferable. Furthermore, when the parameter “R” is 1.0 or less, the internal electrode layer 23 is less likely to be scraped off even when the multilayer section 2s is polished, and loss of electrostatic capacity can be suppressed, which is more preferable.

The distance “a” between the tip P and the side surfaces 2E, 2F illustrated in FIG. 3A is 2.1 to 240.2 (μm), and the thickness “b” of the cover layer is 11.2 to 85.2 (μm). By setting the range of the distance” “a and the thickness “b” in this way, a sufficiently wide area is secured in which the side margin sections 40 and 41 exert their adhesive force against the multilayer section 2s, so peeling of the side margin sections 40 and 41 can be suppressed. Furthermore, it is preferable to set the distance “a” to 5.0 to 200.0 (μm) and the thickness “b” to 10.0 to 90.0 (μm), because this will provide a sufficiently long path for moisture to penetrate from the outside into the multilayer chip 2. More preferably, the distance “a” may be set to 10.0 to 90.0 (μm) and the thickness “b” to 20.0 to 55.0 (μm).

In addition, it is desirable to make the distance “a” appropriately short so that the internal electrode layer 23 is not scraped off even when the multilayer section 2s is polished. For this reason, the distance “a2 is preferably 200 (μm) or less, and more preferably 90 (μm) or less. In addition, since a sufficiently large adhesion force can be obtained between the multilayer section 2s and the side margin sections 40 and 41, the distance “a2 is preferably 5 (μm) or more, and more preferably 10 (μm) or more.

On the other hand, from the viewpoint of miniaturization of the multilayer ceramic capacitor 1, the distance “b” is preferably 90 (μm) or less, and more preferably 55 (μm) or less. In addition, the longer the distance “b” is, the stronger the multilayer ceramic capacitor 1 is against external shocks, and the longer the path for moisture penetration is. For this reason, the distance “b2 is preferably 10 (μm) or more, and more preferably 20 (μm) or more.

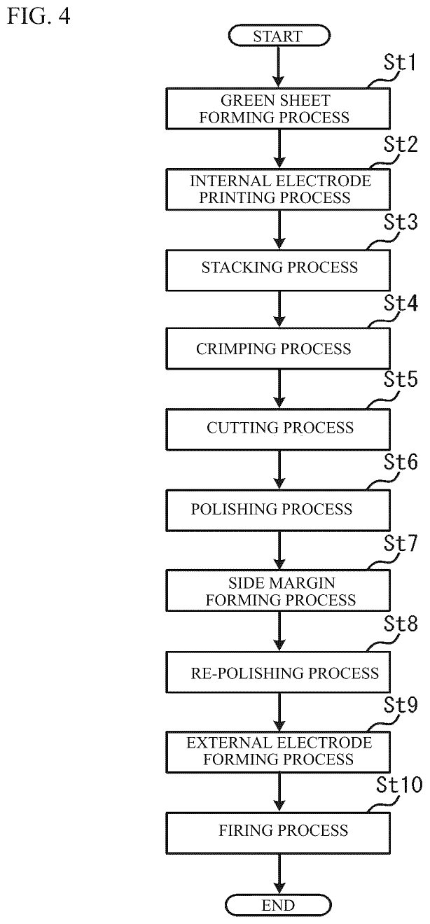

(Manufacturing method of multilayer ceramic capacitor) FIG. 4 is a flow chart of an example of a manufacturing process of the multilayer ceramic capacitor 1. This manufacturing process is an example of a manufacturing method of a multilayer ceramic electronic device.

(Green sheet forming process) First, the green sheet forming process St1 is performed. In this process, for example, a dielectric material obtained by adding various additive compounds (sintering aids and so on) to ceramic powder is wet-mixed with a binder such as polyvinyl butyral (PVB) resin, an organic solvent such as ethanol or toluene, and a plasticizer. The obtained slurry is used to coat a dielectric green sheet on a base material, for example, by a die coater method or a doctor blade method, and then dried. The substrate is, for example, a PET (polyethylene terephthalate) film.

Additive compounds for the ceramic powder is such as oxides of Mg (magnesium), Mn (manganese), V (vanadium), Cr (chromium), a rare earth element (Y (yttrium), Sm (samarium), Eu (europium), Gd (gadolinium), Tb (terbium), Dy (dysprosium), Ho (holmium), Er (erbium), Tm (thulium) or Yb (ytterbium)), as well as oxides or glass of Co (cobalt), Ni, Li (lithium), B (boron), Na (sodium), K (potassium) and Si (silicon).

(Internal electrode printing process) Next, the internal electrode printing process St2 is performed. In this process, a metal conductive paste for forming internal electrodes containing an organic binder is printed by gravure printing on the dielectric green sheet on the base material, so that a plurality of internal electrode patterns corresponding to the internal electrode layers 23 are formed at a distance from each other. Ceramic particles are added to the metal conductive paste as a co-material. The main component of the ceramic particles is not particularly limited, but is preferably the same as the main component ceramic of the dielectric layer 22.

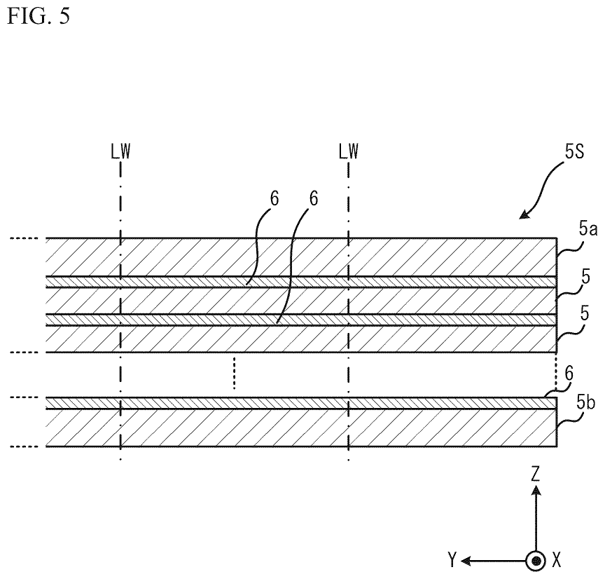

(Stacking process) Next, the stacking process St3 is performed. The following description will be made with reference to FIG. 5.

FIG. 5 is a cross-sectional view of an example of the stacking process St3. In this process, a multilayer sheet 5S is formed by stacking the dielectric green sheets 5 on which an internal electrode pattern 6 that will become the internal electrode layer 23 is printed. The dielectric green sheets 5a and 5b corresponding to the cover layers 20 and 21 are stacked on both end surfaces of the multilayer sheet 5S in the stacking direction.

(Crimping process) Next, the crimping process St4 is performed. In this step, the multilayer sheet 5S is pressed to bond the dielectric green sheets 5, 5a, and 5b together. The bonding means may be, for example, a hydrostatic press, but is not limited to this.

(Cutting process) Next, the cutting process St5 is performed. In this process, the multilayer sheet 5S is cut in the stacking direction along a predetermined cut line LW with a cutting blade, thereby obtaining a plurality of multilayer sections 2s.

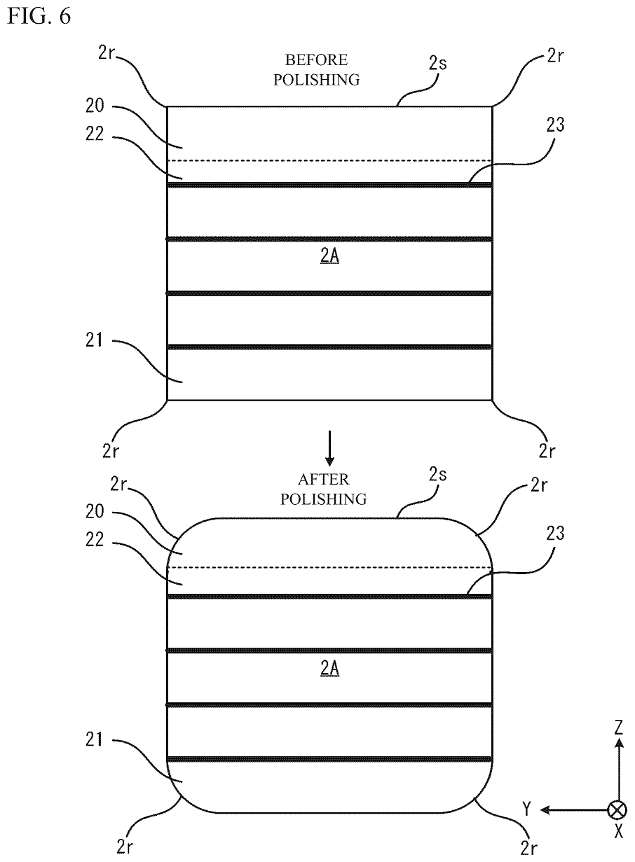

(Polishing process) Next, the polishing process St6 is performed. The following description will be given with reference to FIG. 6.

FIG. 6 is a side view of the multilayer section 2s illustrating an example of the polishing process St6. FIG. 6 illustrates the end surface 2A of the multilayer section 2s before firing. In this step, the multilayer section 2s is polished by a method such as barrel polishing. As a result, the corners 2r of the multilayer section 2s are rounded. At this time, the parameter “R” can be adjusted within the above range by appropriately setting the execution conditions (for example, time, or the like) of the barrel polishing of the multilayer section 2s. In addition, the larger the size of the polishing aid for barrel polishing is, the longer the distance “a” illustrated in FIG. 3A becomes.

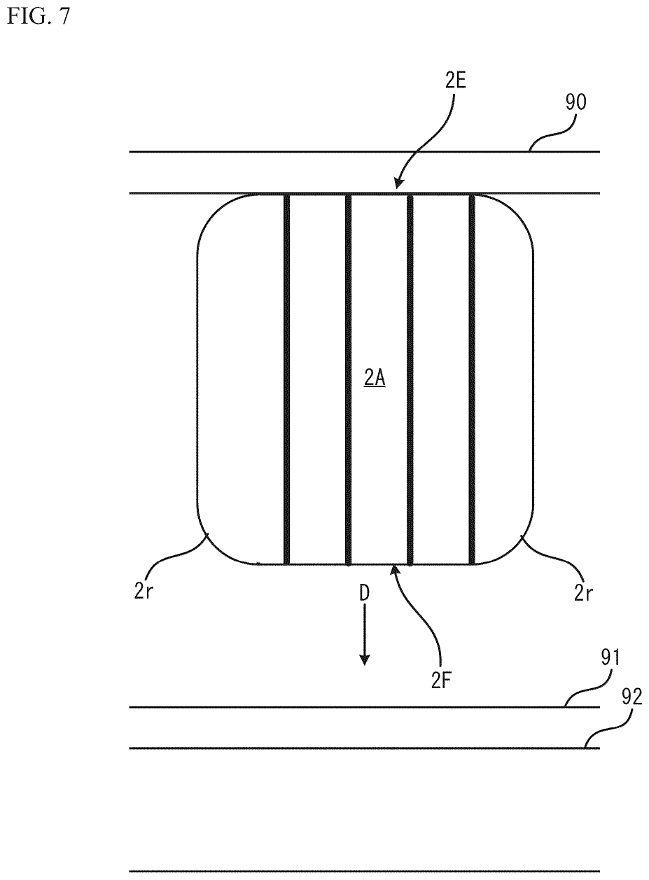

(Side margin forming process) Next, the side margin forming process St7 is performed. This will be explained below with reference to FIGS. 7 to 9.

FIG. 7 to FIG. 9 are side views of an example of the side margin forming process St7 when the end surface 2A of the multilayer section 2s is viewed from the front. In this example, a process of forming the side margin section 41 on one side surface 2F is illustrated, but the process of forming the side margin 40 on the other side surface 2E is the same.

First, as illustrated in FIG. 7, a dielectric green sheet 91 is placed on the plate surface of a flat elastic body 92. One side surface 2E of the multilayer section 2s is fixed with a tape 90, and the multilayer section 2s is placed above it so that the other side surface 2F faces the surface of the dielectric green sheet 91.

Next, the tape 90 is moved downward by a pressing device (not illustrated). This causes the multilayer section 2s to move toward the dielectric green sheet 91 as indicated by the symbol D.

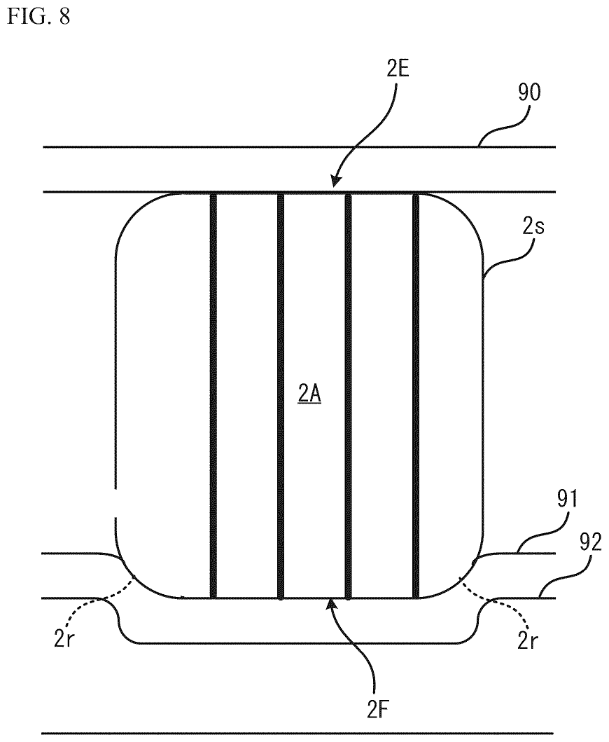

As a result, as illustrated in FIG. 8, the side surface 2F of the multilayer section 2s is pressed against the surface of the dielectric green sheet 91. At this time, the pressed portion of the dielectric green sheet 91 is recessed by the pressure from the multilayer section 2s, and the elastic body 92 below it is also recessed. The corresponding portion of the dielectric green sheet 91 is pressed against the side surface 2F of the multilayer section 2s by the restoring force from the elastic body 92. As a result, a part of the dielectric green sheet 91 is attached to the side surface 2F.

At this time, the dielectric green sheet 91 is attached along the corners 2r of the multilayer section 2s at both ends of the side surface 2F in the stacking direction. When the pressing force on the multilayer section 2s is then increased, a shear force is generated between the attached portion of the dielectric green sheet 91 and the other portion, causing both portions to be separated from each other.

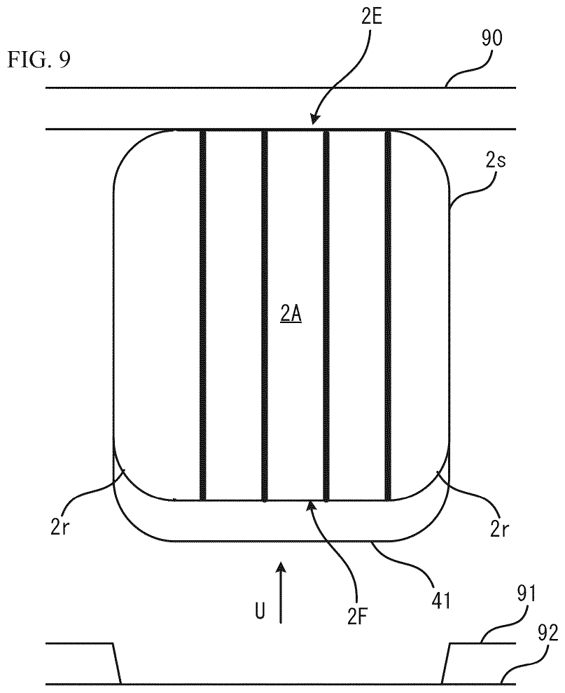

Next, as illustrated in FIG. 9, the tape 90 is moved upward by a pressing device (not illustrated). As a result, the multilayer section 2s moves away from the elastic body 92 as indicated by the symbol U. At this time, the separated portion of the dielectric green sheet 91 is attached to the side surface 2F of the multilayer section 2s, and is formed as the side margin section 41.

In this way, the side margin sections 41 and 40 are formed on the side surfaces 2F and 2E of the multilayer section 2s, respectively, and the multilayer section 2s before firing is produced. If the parameter “R” of the degree of bending of the corner 2r is too large, sufficient shear force may not be necessarily obtained when pressing the multilayer section 2s, and the side margin section 41 may not be necessarily formed properly. From this point of view, it is better to select the elastic body 92 that deforms to a size greater than the size of the corner 2r with a predetermined pressing force.

(Re-polishing process) Next, the re-polishing process St8 is performed. In this process, the multilayer section 2s with the side margin sections 40 and 41 formed is polished again by a method such as barrel polishing. As a result, the corners of the side margin sections 40 and 41 are rounded.

(External electrode forming process) Next, the external electrode forming process St9 is performed. This process is an example of a process for forming a base metal film of the pair of external electrodes 3a and 3b that cover the pair of end surfaces 2A and 2B of the multilayer chip 2 including the side margin sections 40 and 41, and are alternately connected to the internal electrode layers 23 along the stacking direction. In this process, for example, a conductive paste containing metal powder, glass frit, binder, and solvent is applied to each of the end surfaces 2A and 2B, the upper surface 2C, the lower surface 2D, and each of the side surfaces 2E and 2F of the multilayer chip 2. After the conductive paste is applied, the base metal film of the external electrodes 3a and 3b is formed by baking. The binder and the solvent evaporate by baking. An example of a method for applying the conductive paste is a dip method. The base metal film of the external electrodes 3a and 3b may also be formed by a sputtering method.

(Firing process) Next, the firing process St10 is performed. In this process, the multilayer chip 2 on which the external electrodes 3a and 3b are formed is subjected to a binder removal process in an N₂ atmosphere at 250 to 500° C., and then fired in a reducing atmosphere at 1300 to 1400° C. for about one hour, thereby sintering each particle in the multilayer chip 2. In this manner, the manufacturing process of the multilayer ceramic capacitor 1 is carried out. After the firing process, the base metal film of each of the external electrodes 3a and 3b may be plated to form multiple layers of metal coatings such as Cu, Ni, Sn, or the like. For example, the external electrodes 3a and 3b may be formed by forming a Cu-plated layer, a Ni-plated layer, and a Sn-plated layer on the base metal film mainly composed of Ni. The external electrodes 3a and 3b may also be formed by forming a Ni-plated layer and a Sn-plated layer on the base metal film mainly composed of Cu.

In this embodiment, at all of the corners 2r of the multilayer section 2s, the end 4e in the stacking direction of the side margin sections 40 and 41 extends in the width direction so as to cover the ends in the width direction of the cover layers 20 and 21, but this configuration needs to be formed at least in one corner 2r. However, the more corners 2r having the above configuration, the better the effect of suppressing peeling of the side margin sections 40 and 41.

Next, the evaluation results of the multilayer ceramic capacitor 1 of the embodiment will be described.

TABLE 1

| | | | | | | NUMBER OF |
|---|---|---|---|---|---|---|
| | | | | | | PIECES IN |
| | | | | PRESENCE OR | | WHICH |
| | | | | ABSENCE OF | NUMBER | MOISTURE |
| | a | b | R | MANUFACTURING | OF | RESISTANCE |
| SAMPLE No. | (μm) | (μm) | (=a/b) | DEFECT | PEELING | WAS POOR |
| 1 | 0 | 14.6 | 0 | ABSENCE | 2/1000 | 1/200 |
| 2 | 2.1 | 11.2 | 0.2 | ABSENCE | 0/1000 | 0/200 |
| 3 | 9.5 | 32.3 | 0.3 | ABSENCE | 0/1000 | 0/200 |
| 4 | 57.7 | 80.4 | 0.7 | ABSENCE | 0/1000 | 0/200 |
| 5 | 36.5 | 36.7 | 1.0 | ABSENCE | 0/1000 | 0/200 |
| 6 | 14.8 | 12.0 | 1.2 | ABSENCE | 0/1000 | 0/200 |
| 7 | 20.0 | 11.3 | 1.8 | ABSENCE | 0/1000 | 0/200 |
| 8 | 240.2 | 85.2 | 2.8 | ABSENCE | 0/1000 | 0/200 |
| 9 | 284.2 | 91.4 | 3.1 | PRESENCE | — | — |

Table 1 shows the distance “a”, the thickness “b”, the parameter “R”, presence or absence of manufacturing defects, the number of pieces in which the side margin sections 40 and 41 peeled off, and the number of pieces in which the moisture resistance was poor for the multilayer ceramic capacitor samples No. 1 to 9. Samples No. 1 to 9 were produced in 1000 pieces according to the above manufacturing process and evaluated. The distance “a” and the thickness “b” were calculated as the average value of 20 pieces taken from each of the 1000 pieces of the samples No. 1 to 9. The size of the samples No. 1 to 9 was 1.0 (mm) in length, 0.5 (mm) in width, and 0.5 (mm) in height, and the rated voltage of the samples No. 1 to 9 was 10 (V).

The distance “a”, the thickness “b”, and the parameter “R” of each of the samples No. 1 to 9 are different. The distance “a”, the thickness “b”, and the parameter “R” were adjusted by the polishing step St6 described above.

The samples No. 2 to 9 are multilayer ceramic capacitors 1 of the embodiment illustrated in FIG. 3A. A curved surface was formed at all of the corners 2r of the multilayer section 2s of the samples No. 2 to 9. As a result, at all of the corners 2r, the ends 20e and 21e of the cover layers 20 and 21 were covered by the ends 4e of the side margin sections 40 and 41.

The sample No. 1 is the comparative multilayer ceramic capacitor 1a illustrated in FIG. 3B. No curved surface was formed at each corner of the multilayer section 2s of the sample No. 1. The evaluation results are described below.

(Presence or absence of manufacturing defects) After the side margin forming process St7, it was confirmed whether the side margin sections 40 and 41 of each sample No. 1 to 9 were formed normally. Only the side margin sections 40 and 41 of the sample No. 9, which had the largest parameter “R2, were not formed normally, and the manufacturing defect was “present”. The side margin sections 40 and 41 of the other samples No. 1 to 8 were formed normally. The number of pieces confirmed was 1000 for each of the samples No. 1 to No. 8.

As described above, the larger the parameter “R” is, the greater the degree of bending of the corners 2r of the multilayer section 2s is. For this reason, as described with reference to FIG. 7 to FIG. 9, in the side margin forming process St7, a sufficient shear force is not obtained to peel off a part of the dielectric green sheet 91 attached to the side surface 2F of the multilayer section 2s from the other parts. For this reason, from the viewpoint of ease of manufacturing, it is preferable that the parameter “R” is 2.8 or less. Furthermore, if the parameter “R” is 1.0 or less, the internal electrode layer 23 is less likely to be scraped off in the polishing process St6, and the loss of electrostatic capacity can be suppressed, which is even more preferable. In addition, since the side margin sections 40 and 41 of the sample No. 9 could not be formed normally, the peeling and moisture resistance were not evaluated.

(Whether or not the side margin sections peel off) After the above-mentioned firing process St10, the side margin sections 40 and 41 of the samples No. 1 to 8 were visually inspected for the presence or absence of peeling. The number of inspections was 1000 for each of the samples No. 1 to 8.

For the sample No. 1, which has the parameter “R” of 0, peeling of the side margin sections 40 and 41 was confirmed in two out of 1000 pieces. In contrast, peeling of the side margin sections 40 and 41 was not confirmed in any of the other samples No. 2 to 8.

The smaller the parameter “R” is, the smaller the degree of bending of the corner 2r of the multilayer section 2s is. Therefore, when the parameter “R” is 0 as in the sample No. 1, a sufficient contact area cannot be secured between the side margin sections 40 and 41 and the multilayer section 2s, and the adhesive force between the multilayer section 2s and the side margin sections 40 and 41 becomes insufficient.

(Evaluation of moisture resistance) In the evaluation of moisture resistance, a rated voltage of 10 (V) was applied to 200 pieces of each of the samples No. 1 to 8 under conditions of a temperature of 45 (C) and a humidity of 95(%) and held for a specified time, and the electrical resistance of the samples 1 to 8 was measured. Multilayer ceramic capacitors with an electrical resistance of 10 (MΩ) or more were judged to be “good”, and multilayer ceramic capacitors with an electrical resistance of less than 10 (MΩ) were judged to be “bad”.

As a result of the evaluation of moisture resistance, one out of 200 pieces of sample No. 1, which has a parameter “R2 of 0, was judged to be “bad”. In contrast, all 200 samples of the other samples No. 2 to 8 were judged to be “good”. The smaller the parameter “R” is, the smaller the degree of bending of the corner 2r of the multilayer section 2s is, and therefore the shorter the distance from the outside to the internal electrode layer 23 along the boundary between the side margin sections 40, 41 and the multilayer section 2s is, and the peeling of the side margin sections 40 and 41 is likely to allow moisture to enter the inside, which will affect the characteristics of the multilayer ceramic capacitor 1.

Thus, from the viewpoint of preventing peeling of the side margin sections 40, 41 and improving moisture resistance, it is preferable that the parameter “R” is 0.2 or more. When the parameter “R” is 0.2 or more, a sufficiently large adhesion force is obtained between the multilayer section 2s and the side margin sections 40 and 41, so that peeling of the side margin sections 40, 41 can be more effectively suppressed. Furthermore, it is more preferable to set the parameter “R” to 0.3 or more, because a larger adhesion force can be obtained between the multilayer section 2s and the side margin sections 40 and 41. Furthermore, it is more preferable that the parameter “R” is 0.5 or more, because the path through which moisture penetrates becomes sufficiently long.

Furthermore, when the distance “a” is set to 2.1 to 240.2 (μm) and the thickness “b” of the cover layer is set to 11.2 to 85.2 (μm), a sufficiently wide area is secured in which the side margin sections 40 and 41 exert their adhesion force against the multilayer section 2s, so that peeling of the side margin sections 40 and 41 can be suppressed. In this case, the moisture penetration path is sufficiently long, and therefore the moisture resistance is improved. Furthermore, it is preferable to set the distance “a” to 5.0 to 200.0 (μm) and the thickness “b” to 10.0 to 90.0 (μm), since the moisture penetration path from the outside to the multilayer chip 2 is sufficiently long, and more preferably, the distance “a” may be set to 10.0 to 90.0 (μm) and the thickness “b” to 20.0 to 55.0 (μm).

Here, it is desirable to appropriately shorten the distance “a” so that the internal electrode layer 23 is not scraped in the polishing process St6. For this reason, the distance “a” is preferably 200 (μm) or less, and more preferably 90 (μm) or less. Furthermore, it is preferable to set the distance “a” to 5 (μm) or more, and more preferably 10 (μm) or more, since a sufficiently large adhesion force can be obtained between the multilayer section 2s and the side margin sections 40 and 41.

On the other hand, from the viewpoint of miniaturizing the multilayer ceramic capacitor 1, it is preferable that the distance “b” be 90 (μm) or less, and more preferably 55 (μm) or less. Furthermore, the longer the distance “b” is, the stronger the multilayer ceramic capacitor 1 will be against external shocks, and the shorter the path for moisture in penetration is. For this reason, it is preferable that the distance “b” be 10 (μm) or more, and more preferably 20 (μm) or more.

Although the embodiments of the present invention have been described in detail, it is to be understood that the various change, substitutions, and alterations could be made hereto without departing from the spirit and scope of the invention.

1. A multilayer ceramic electronic device comprising:
a multilayer section that has a substantially rectangular parallelepiped shape and includes each of a plurality of internal electrode layers and each of a plurality of dielectric layers which are alternately stacked, and a cover layer provided outside in a stacking direction of the plurality of internal electrode layers and the plurality of dielectric layers;
a side margin section that is provided on a side surface facing in a first direction orthogonal to the stacking direction among six surfaces of the multilayer section; and
an external electrode that is provided on an end surface facing in a second direction orthogonal to the first direction and the stacking direction among the six surfaces of the multilayer section and is connected to at least one of the plurality of internal electrode layers,
wherein, when viewing a cross section of the multilayer section along the stacking direction and the first direction, at least at one corner of the multilayer section, a first end of the side margin section in the stacking direction contacts a second end of the cover layer in the first direction from the stacking direction, and
wherein a ratio of a distance in the first direction between a tip of the first end of the side margin section and the side surface to a thickness of the cover layer in the stacking direction is 2.8 or less.

2. The multilayer ceramic electronic device as claimed in claim 1,
wherein the at least one corner has a curved surface that is convex outward, and
wherein the first end is in contact with the curved surface provided at the second end in the stacking direction.

3. The multilayer ceramic electronic device as claimed in claim 1,
wherein the ratio of the distance in the first direction between the tip of the first end of the side margin section and the side surface to the thickness of the cover layer in the stacking direction is 0.2 or more.

4. The multilayer ceramic electronic device as claimed in claim 1,
wherein the ratio of the distance in the first direction between the tip of the first end of the side margin section and the side surface to the thickness of the cover layer in the stacking direction is 0.5 or more.

5. The multilayer ceramic electronic device as claimed in claim 1,
wherein the ratio of the distance in the first direction between the tip of the first end of the side margin section and the side surface to the thickness of the cover layer in the stacking direction is 1.0 or less.

6. The multilayer ceramic electronic device as claimed in claim 1,
wherein the distance in the first direction between the tip of the first end and the side surface is 2.1 to 240.2 μm, and
wherein the thickness of the cover layer in the stacking direction is 11.2 to 85.2 μm.

7. The multilayer ceramic electronic device as claimed in claim 1,
wherein the distance in the first direction between the tip of the first end and the side surface is 5.0 to 200.0 μm, and
wherein the thickness of the cover layer in the stacking direction is 10.0 to 90.0 μm.

8. The multilayer ceramic electronic device as claimed in claim 1,
wherein the distance in the first direction between the tip of the first end and the side surface is 10.0 to 90.0 μm, and
wherein the thickness of the cover layer in the stacking direction is 20.0 to 55.0 μm.

9. A manufacturing method of a multilayer ceramic electronic device comprising:
polishing a multilayer section that has a substantially rectangular parallelepiped shape and includes each of a plurality of internal electrode layers and each of a plurality of dielectric layers which are alternately stacked, and a cover layer provided outside in a stacking direction of the plurality of internal electrode layers and the plurality of dielectric layers;
forming a side margin section that is provided on a side surface facing in a first direction orthogonal to the stacking direction among six surfaces of the multilayer section; and
forming an external electrode that is provided on an end surface facing in a second direction orthogonal to the first direction and the stacking direction among the six surfaces of the multilayer section and is connected to at least one of the plurality of internal electrode layers,
wherein, in the forming of the side margin section, the side margin section is formed so that, when viewing a cross section of the multilayer section along the stacking direction and the first direction, at least at one corner of the multilayer section, a first end of the side margin section in the stacking direction contacts a second end of the cover layer in the first direction from the stacking direction, and a ratio of a distance in the first direction between a tip of the first end of the side margin section and the side surface to a thickness of the cover layer in the stacking direction is 2.8 or less.

10. The method as claimed in claim 9,
wherein, in the polishing of the multilayer section, a curved surface that is convex outward is formed at the at least one corner, and
wherein, in the forming of the side margin section, the side margin section is formed so that the first end is in contact with the curved surface provided at the second end in the stacking direction.
